(19) United States
(12) Patent Application Publication
(10) Pub. No.: US 2026/0133061 A1
(43) Pub. Date: May 14, 2026

(54) Water Meter Pit

(71) Applicant: Hydrant Tech Inc., Tecumseh (CA)

(72) Inventor: Timothy Elvidge, Tecumseh (CA)

(21) Appl. No.: 19/387,802

(22) Filed: Nov. 13, 2025

Related U.S. Application Data
(60) Provisional application No. 63/719,733, filed on Nov. 13, 2024.

(51) Int. Cl. G01F 15/14; G01F 15/18

(52) U.S. Cl. CPC G01F 15/14; G01F 15/185

(57) ABSTRACT

A meter pit for housing one or more flow meters below a ground surface. The meter pit includes a cylindrical body, a plurality of inflow pipes, and a plurality of outflow pipes. The cylindrical body extends between a top end and a bottom end and defines an interior. Each of the plurality of inflow pipes is connected to one of the one or more flow meters. Each of the plurality of outflow pipes is connected to one of the one or more flow meters.

### CROSS-REFERENCE TO RELATED APPLICATIONS

The subject patent application claims priority to, and all the benefits of, United States Provisional Patent Application № 63/719,733, filed on November 13, 2024, the entire contents of which are incorporated by reference herein.

### BACKGROUND

In many areas, fresh water is supplied to a property by a water utility company. A water meter is connected to the main water supply line and the property's plumbing system and measures the amount of water used by a property. The water meter is a precision instrument that records the volume of water usage, typically in gallons or liters, depending on the local utility's standards. Some modern water meters are equipped with remote reading technology, allowing utility companies to monitor water usage without needing to physically access the meter. Oftentimes, the water meter is located inside a residential home, which protects the meter from adverse conditions (e.g., freezing) or other damage. However, if the local utility needs access to the water meter for service or a manual reading it must be coordinated with the property owner, which can be difficult or prone to delay. In order to provide the local utility unencumbered access to the water meter, the water meter may be installed outdoors in a water meter pit.

A water meter pit is an underground enclosure that houses the water meter. Typically located near the property line, the pit is designed to protect the meter from environmental elements and potential tampering. The pit is usually made of durable materials like concrete, plastic, or fiberglass, ensuring it can withstand various weather conditions and physical impacts. The lid of the pit is often insulated and lockable, providing easy access for maintenance while keeping the meter secure.

The design and installation of a water meter pit must comply with local regulations and standards to ensure safety and accuracy. Proper installation includes ensuring the pit is at the correct depth to prevent freezing in colder climates and that it is easily accessible for routine inspections and maintenance. Regular maintenance of the pit and meter is crucial to ensure accurate readings and to prevent any potential water loss or damage to the property. Overall, a well-maintained water meter pit is valuable for effective water management and conservation.

### SUMMARY

In one aspect, a housing for supporting one or more flow meters underground includes a cylindrical body, a plurality of inflow pipes, and a plurality of outflow pipes. The cylindrical body extends between a top end and a bottom end and defines an interior. Each of the plurality of inflow pipes is connected to one of the one or more flow meters. Each of the plurality of outflow pipes is connected to one of the one or more flow meters.

In another aspect, a housing for supporting a flow meter underground includes a cylindrical body, a support beam, an inflow pipe, and an outflow pipe. The cylindrical body extends between a top end and a bottom end and defines an interior. An aperture extends through the cylindrical body into the interior. The aperture is arranged proximate to the bottom end of the cylindrical body. The support beam is arranged in the interior and coupled to the cylindrical body. The inflow pipe and the outflow pipe each extends through the aperture and is coupled to the support beam such that the inflow pipe and the outflow pipe are at least partially arranged in the interior. Each of the inflow pipe and the outflow pipe is configured to be fluidly coupled to the flow meter.

Any of the above aspects can be combined in full or in part. Any features of the above aspects can be combined in full or in part. Any of the above implementations for any aspect can be combined with any other aspect. Any of the above implementations can be combined with any other implementation whether for the same aspect or a different aspect.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a front perspective view of a first embodiment of a water meter pit for housing a plurality of water meters.

FIG. 2 is a cross-sectional side view of the water meter pit of FIG. 1 showing one of the water meters, an inflow pipe and an inflow valve, an outflow pipe and an outflow valve, a support beam, and a brace.

FIG. 3 is a top view of the water meter pit of FIG. 1 showing the plurality of water meters disposed therein.

FIG. 4 is a front perspective view of a second embodiment of the water meter pit showing a cylindrical body and a support liner in a first height configuration.

FIG. 5 is a front perspective view of the water meter pit of FIG. 4 showing the cylindrical body and the support liner in a second height configuration.

FIG. 6A is a perspective view of the water meter pit of FIG. 4 showing the cylindrical body in a retracted height configuration.

FIG. 6B is a perspective view of the water meter pit of FIG. 4 showing the cylindrical body in an intermediate height configuration.

FIG. 6C is a perspective view of the water meter pit of FIG. 4 showing the cylindrical body in an extended height configuration.

FIG. 7 is a top view of the water meter pit of FIG. 4 showing one of the water meters, inflow and outflow pipes, and inflow and outflow valves.

FIG. 8 is a cross-sectional side view of the water meter pit of FIG. 4 showing one of the water meters, a support beam, and a brace.

### DETAILED DESCRIPTION

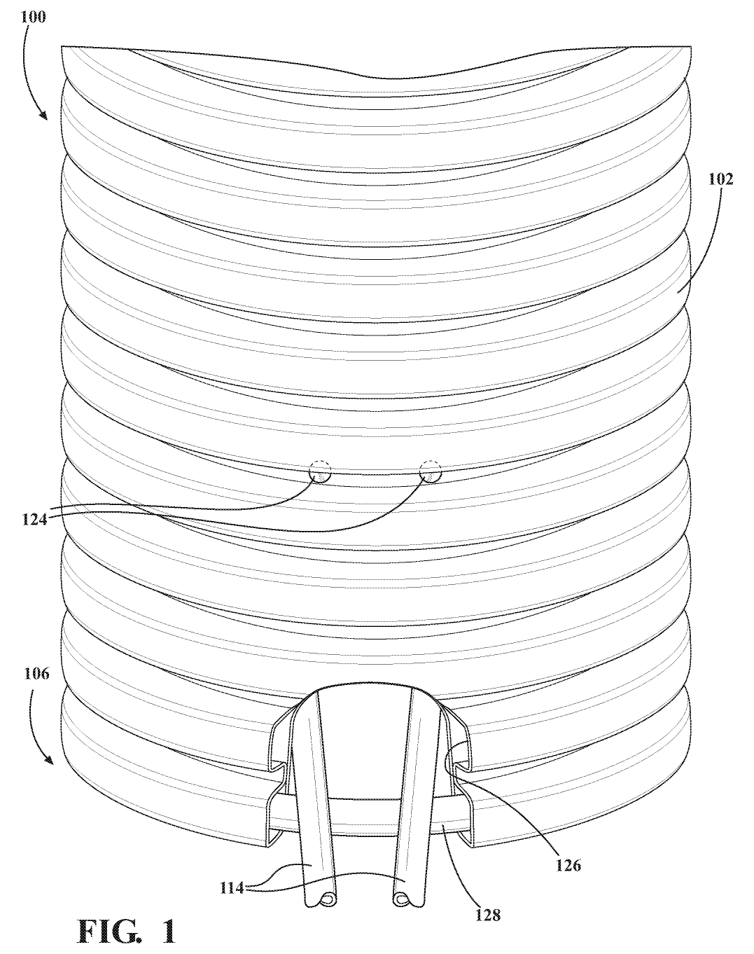

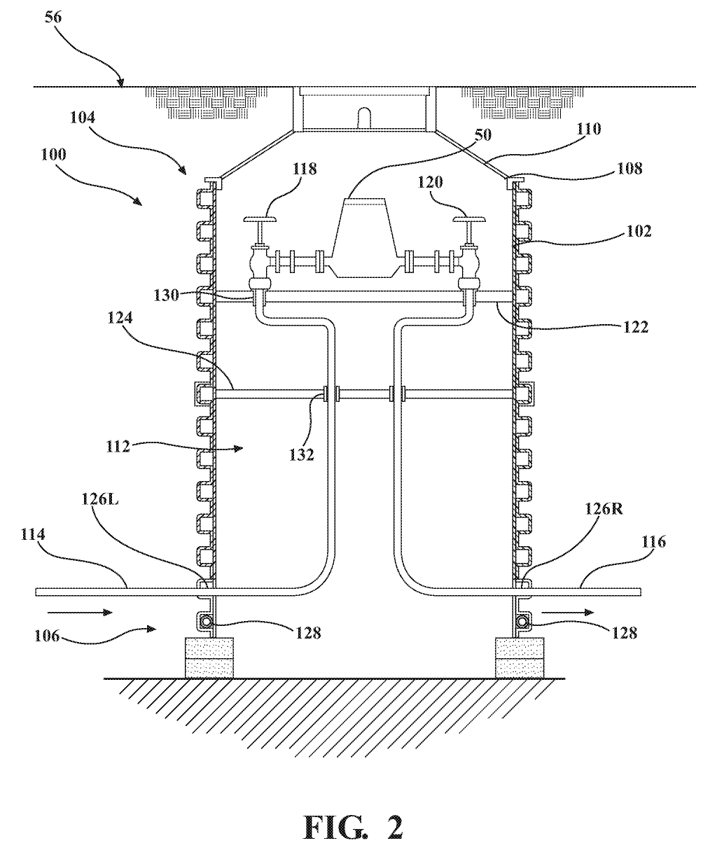

A meter pit 100 enclosure for housing one or more flow meters 50 is shown in FIGS. 1 and 2. The meter pit 100 provides protection and access to the flow meters 50. In FIG. 1 the meter pit 100 is shown prior to installation in the ground, whereas in FIG. 2 the meter pit 100 is shown installed underground. The meter pit 100, also referred to as a housing, includes a continuous cylindrical body 102 extending between an open top end 104 and a bottom end 106. The top end 104 includes a rim 108 extending radially outward and configured to rest on the surface 56 of the ground. The cylindrical body 102 may be formed from a corrugated pipe. More specifically, the cylindrical body 102 shown here is formed from a high-density polyethylene dual wall corrugated pipe. The meter pit 100 may further include a lid 110 that is supported on the rim 108 to enclose an interior 112 of the cylindrical body 102.

The meter pit 100 further includes a plurality of inflow pipes 114, each of which is configured to fluidly couple to a mains water supply, and a plurality of outflow pipes 116, each of which is configured to fluidly couple to a building’s plumbing. The meter pit 100 may further include a plurality of inflow valves 118, each coupled to one of the plurality of inflow pipes 114, and a plurality of outflow valves 120, each coupled to one of the plurality of outflow pipes 116. Each one of the plurality of inflow pipes 114 and plurality of inflow valves 118 are connected to one of the plurality of flow meters 50. Similarly, each one of the plurality of outflow pipes 116 and plurality of outflow valves 120 are connected to one of the plurality of flow meters 50. Said differently, each of the plurality of flow meters 50 is coupled to one of the plurality of inflow valves 118 and plurality of outflow valves 120, which are in turn coupled to one of the plurality of inflow pipes 114 and plurality of outflow pipes 116, respectively. As such, water flows into each inflow pipe 114, through a corresponding inflow valve 118, into the flow meter 50, through the corresponding outflow valve 120, and into the outflow pipe 116. The inflow valves 118 and outflow valves 120 are brass ball type valves that are coupled between the flow meter 50 and the inflow or outflow pipes 114, 116. While the meter pit 100 illustrated herein includes two flow meters 50, it should be appreciated that other implementations of the meter pit (not shown) may include more or fewer flow meters 50. For example, some implementations of the meter pit 100 may be configured to house only a single flow meter and others may be configured to house three or more flow meters.

Each combination of an inflow pipe 114, inflow valve 118, flow meter 50, outflow valve 120, and outflow pipe 116 is capable of measuring the volume or amount of water supplied to a single building. Each of the embodiments of the meter pit 100 shown here include two flow meters 50. As such, each meter pit 100 includes two inflow pipes 114, two inflow valves 118, two outflow valves 120, and two outflow pipes 116. In this way, the meter pit 100 is configured to measure the amount of water supplied to two water customers. The meter pit 100 may be used to supply multiple separate buildings or multiple units within a single building. The meter pit 100 may be configured to measure the amount of water supplied to three separate buildings with the addition of another flow meter 50, inflow pipe 114, inflow valve 118, outflow valve 120, and outflow pipe 116. The inflow valves 118 control the flow of water from the inflow pipes 114 into the flow meters 50. Similarly, the outflow valves 120 control the flow of water from the flow meters 50 into the outflow pipes 116.

The inflow pipes 114 and the outflow pipes 116 are flexible pipes, and each has a length greater than a distance defined between the top end 104 and the bottom end 106 of the cylindrical body 102. As such, a portion of each of the inflow and outflow pipes 114, 116 protrudes from the cylindrical body 102, the protruding portion of the inflow pipes 114 being usable for connecting to a main water supply and the protruding portion of the outflow pipes 116 being usable for connecting to a building. Here, the inflow pipes 114 and the outflow pipes 116 are formed from a flexible polyethylene pipe, however other pipe materials are contemplated.

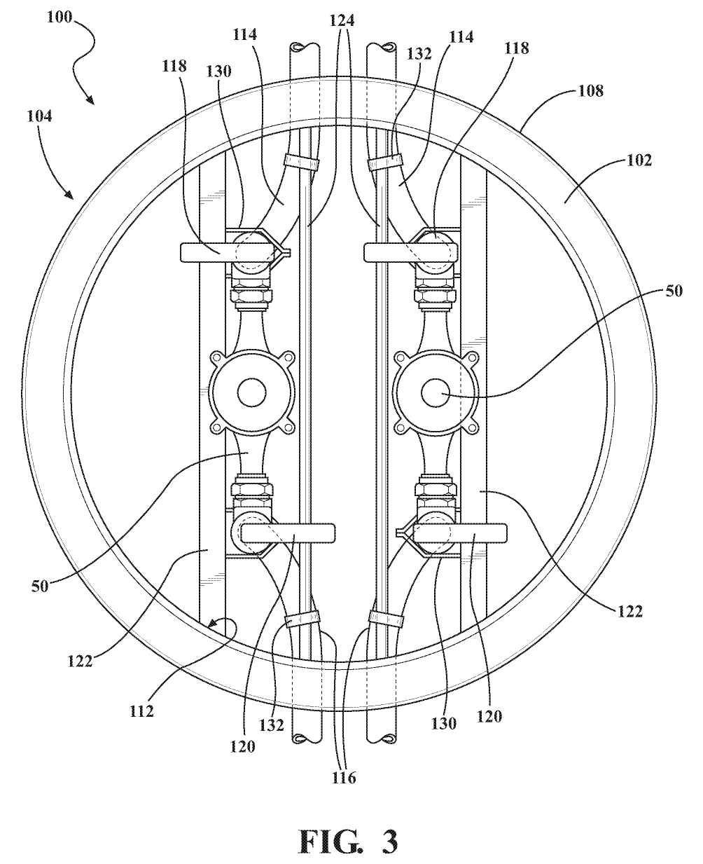

Referring to FIGS. 2 and 3, the meter pit 100 may further include a support beam 122, which is arranged inside the cylindrical body 102 and extends horizontally across the cylindrical body 102. The support beam 122 is coupled to the cylindrical body 102. Each of the inflow valves 118 and the outflow valves 120 is coupled to the support beam 122 to provide support to the flow meters 50. The support beam 122 may include a plurality of clamps or brackets 132 configured to couple the inflow and outflow pipes 114, 116 or the inflow and outflow valves 118, 120 to the support beam 122 in order provide support to each of the plurality of flow meters 50.

The meter pit 100 may further include a brace 124, which is arranged inside the cylindrical body 102 and below the support beam 122 and extends horizontally across the cylindrical body 102. The brace 124 provides support to the plurality of inflow pipes 114 and the plurality of outflow pipes 116. The brace 124 may also secure surplus length of the flexible inflow pipes 114 and outflow pipes 116 through various attachment mechanisms 132 such as clamps or plastic ties.

In FIG. 2, the meter pit 100 is shown installed below the ground surface 56. The inflow pipes 114 are shown entering the meter pit 100 near the bottom end 106 of the cylindrical body 102. Similarly, the outflow pipes 116 are shown exiting the meter pit 100 near the bottom end 106 of the cylindrical body 102. The brace 124 supports the inflow and outflow pipes 114, 116 in the cylindrical body 102, which may prevent the pipes from kinks or other damage during installation. Similarly, the support beam 122 supports the inflow and outflow valves 118, 120 as well as the flow meters 50. The support provided by the support beam 122 allows the flow meters 50 to be installed and serviced without flexing the inflow and outflow pipes 114, 116. Additionally, the support beam 122 maintains the height of the flow meters 50 within the cylindrical body 102, and therefore the height relative to the ground surface 56.

With renewed reference to FIGS. 1 and 2, an inlet aperture 126 is defined in the cylindrical body 102 at the bottom end 106 of the cylindrical body 102. More specifically, two inlet apertures 126 may be defined in the cylindrical body 102. One inlet aperture 126 may allow the inflow pipes 114 to enter the meter pit 100 while another inlet aperture 126 may allow the outflow pipes 116 to exit the meter pit 100. In FIG. 2, the inflow pipes 114 are shown on the left side of the interior 112 and entering through the inlet aperture 126L on the left, and the outflow pipes 116 are shown on the right side of the interior 112 and exiting through the inlet aperture 126R on the right. It should be appreciated that the inflow pipes 114 and the outflow pipes 116 can be arranged on either of the left or right sides of the interior 112 and protrude through either of the left or right inlet apertures 126L, 126R. In other words, the inflow pipes 114 may be arranged on the left side of the interior 112 and enter through the right inlet aperture 126R and the outflow pipes 116 may be arranged on the right side of the interior 112 and exit through the left inlet aperture 126L. As used here, left and right are relative to the schematic representation in FIG. 2. Relative orientations and directions (by way of example, distal, proximal, upper, lower, bottom, rearward, front, rear, back, outboard, inboard, inward, outward, lateral, left, right) are set forth in this description not as limitations, but for the convenience of the reader when describing the structures illustrated herein.

The meter pit 100 may further include a lower rim section 128 arranged at a bottom side of each inlet aperture 126. The lower rim section 128 provides structural integrity to the inlet aperture 126 and the bottom end 106 of the cylindrical body 102. The inlet aperture 126 may be formed by removing a portion of the cylindrical body 102 at the bottom end 106. A gap in the bottom end 106 resulting from the removed portion of the cylindrical body 102 may be enclosed by the lower rim section 128. Here, the lower rim section 128 may be formed from a short piece of flexible pipe that has been secured to the cylindrical body 102. As shown here, in embodiments in which the cylindrical body 102 is implemented as a corrugated pipe, the lower rim section 128 may be sized so as to fit within one of the corrugations that form the cylindrical body 102.

In addition to strengthening the bottom end 106 of the cylindrical body 102, the lower rim section 128 prevents the inflow pipes 114 and the outflow pipes 116 from falling out of the inlet aperture 126 during installation of the meter pit 100 at a jobsite. The inlet aperture 126 offers several advantages during installation of the meter pit 100. A first advantage is movement of the inflow and outflow pipes 114, 116 due to the size of the inlet aperture 126. More specifically, because the inflow and outflow pipes 114, 116 are not rigidly fixed to the cylindrical body 102 and are able to move within the inlet aperture 126, if one of the inflow and outflow pipes 114, 116 contacts the ground or other obstacle during installation of the meter pit 100 the force is not transferred to the cylindrical body 102. Said differently, if either of the inflow and outflow pipes 114, 116 was rigidly fixed to the cylindrical body 102, forces from an impact would be transferred into the cylindrical body 102, which may pinch or otherwise damage the inflow and outflow pipes 114, 116.

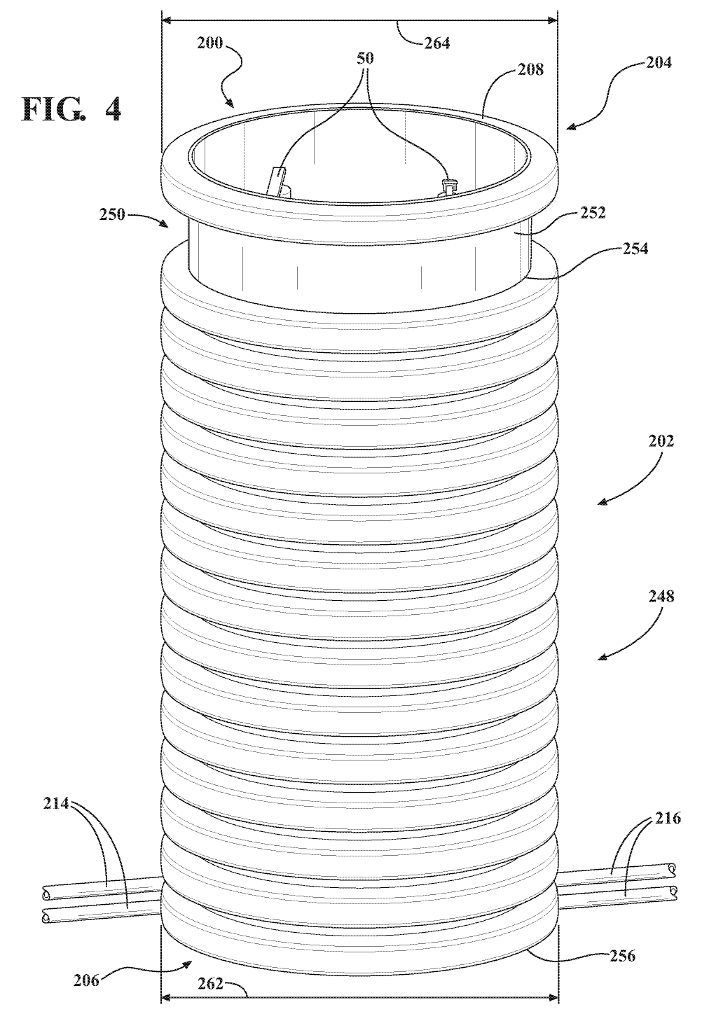

Turning now to FIGS. 4-8, a second implementation of the meter pit 200 is shown. As will be appreciated from the subsequent description below, the second meter pit 200 is similar to the meter pit 100 described above in connection with FIGS. 1-3. As such, the components and structural features of the second implementation of the meter pit 200 that are the same as, or that otherwise correspond to, the first implementation of the meter pit 100 are provided with the same reference numerals increased by 100 (e.g., 100 and 200). While the specific differences between these implementations will be described in detail, for the purposes of clarity, consistency, and brevity, only certain structural features and components common between these implementations will be discussed and depicted in the drawings of the second implementation of the meter pit 200. Here, unless otherwise indicated, the above description of the first implementation of the meter pit 100 may be incorporated by reference with respect to the second implementation of the meter pit 200 without limitation.

Here, the meter pit 200 includes a cylindrical body 202, extending between a top end 204 and a bottom end 206 and defining an interior 212. The cylindrical body 202 includes a lower portion 248 and an upper portion 250 including a support liner 252. The upper portion 250 extends from the open top end 204 to a liner opening 260. The open top end 204 has a rim 208 coupled to the support liner 252. Here, the support liner 252 is formed from metal that has been formed into a cylinder, and the rim 208 is formed from a segment of corrugated pipe, which is secured to the top end 204 of the upper portion 250. The rim 208 of the upper portion 250 and the lower portion 248 each have an outer diameter 262, 264. More specifically, the lower portion 248 has a first diameter 262 and the rim 208 has a second outer diameter 264. The second outer diameter 264 of the rim 208 is equal to the first outer diameter 262 of the lower portion 248.

Similar to the cylindrical body 102 described above in connection with the first embodiment of the meter pit 100, the upper portion 250 of the cylindrical body 202 of the second embodiment of the meter pit 200 houses the inflow and outflow valves 218, 220 and the plurality of flow meters 50. Here, the support beams 222 may be coupled to the upper portion 250 for supporting the inflow and outflow valves 218, 220 and the plurality of flow meters 50. The support beams 222 may be coupled to the support liner 252 by welding. The meter pit 200 may further include a brace 224 arranged in the interior 212 below the support beam 222. The brace 224 may be coupled to the cylindrical body 202. Here, the brace 224 is shown coupled to the lower portion 248, however in alternative implementations the brace 224 may be coupled to the support liner 252. The inflow pipes 214 and the outflow pipes 216 are coupled to the brace 224 to provide additional support and positional restraint to the inflow and outflow pipes 214, 216.

As with above, the second embodiment of the meter pit 200 includes two flow meters 50, however it should be appreciated that other implementations of the meter pit (not shown) may include more or fewer flow meters 50. For example, some implementations of the meter pit 200 may be configured to house only a single flow meter and others may be configured to house three or more flow meters.

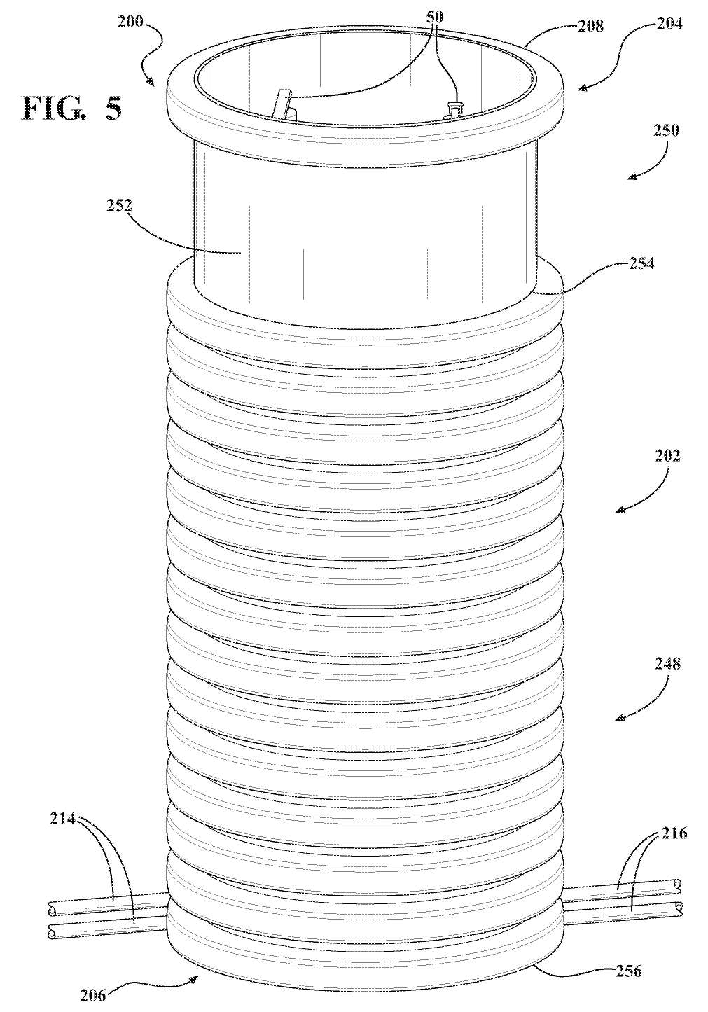

As mentioned above, the cylindrical body 202 includes the upper portion 250, which is slidably engaged with the lower portion 248. Here, the lower portion 248 is formed from corrugated pipe and extends from a top opening 254 to a bottom opening 256. The top opening 254 of the lower portion 248 receives the liner opening 260 of the upper portion 250. The bottom opening 256 of the lower portion 248 is supported below the ground surface 56. In this way, the upper portion 250 is movable relative to the lower portion 248 to adjust an overall height of the cylindrical body 202 and the meter pit 200. The support liner 252 is movably disposed in the lower portion 248 and configured to adjust a height of the meter pit 200. Said differently, the rim 208 can be raised and lowered relative to the bottom opening 256 of the lower portion 248 to position the top end 204 of the upper portion 250 at an ideal height relative to the ground surface 56. For example, FIG. 5 shows the rim 208 spaced further from the top opening 254 than in FIG. 4. The adjustable height of the meter pit 200 facilitates ease of installation by reducing the accuracy required when digging the hole in the ground surface 56 as well as eliminating a step of shimming the bottom of the meter pit 200 in the hole.

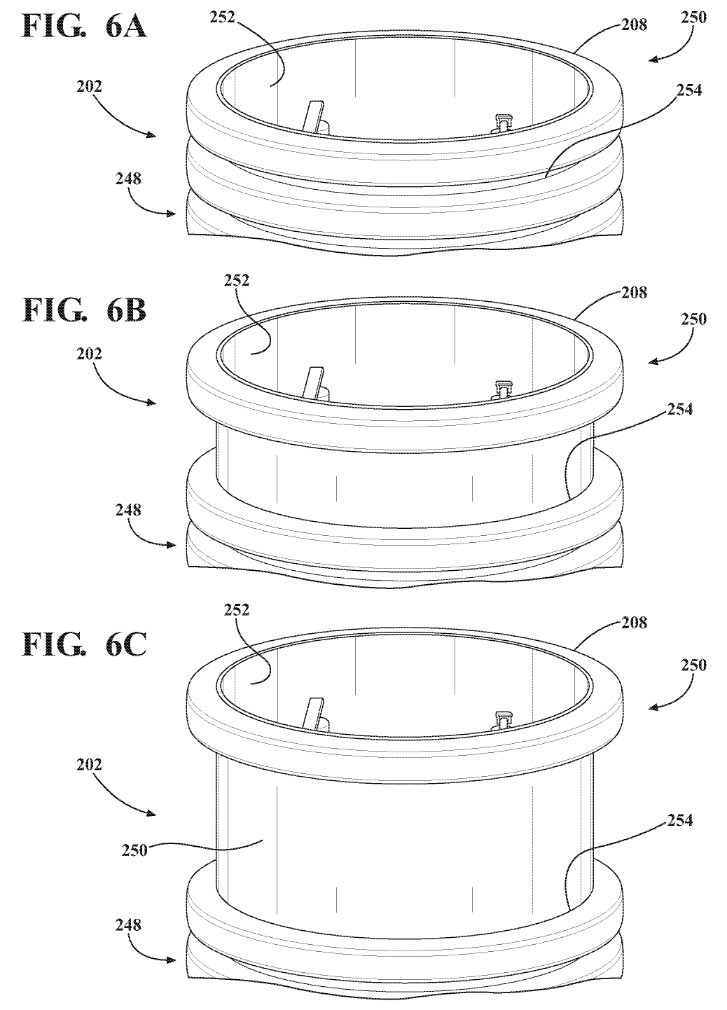

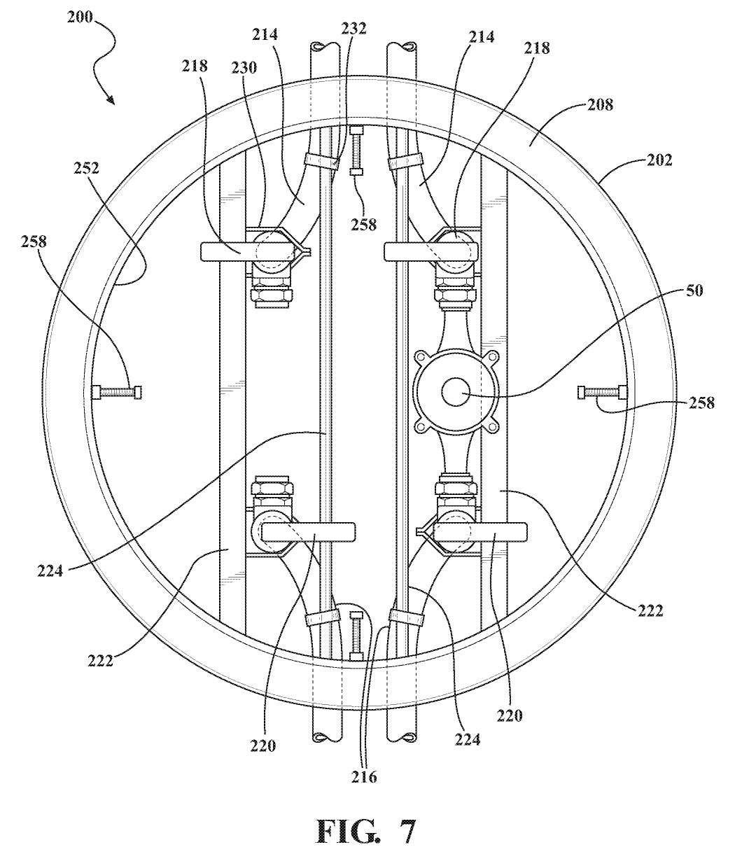

Referring to FIGS. 6A-6C, the meter pit 200 is shown in three different height configurations. More specifically, the sliding arrangement of the lower portion 248 and the upper portion 250 is shown in a retracted (shortened) configuration in FIG. 6A, an intermediate configuration in FIG. 6B, and an extended (lengthened) configuration in FIG. 6C. Turning to FIG. 7, once the height of the upper portion 250 has been chosen, fasteners 258 may be used to secure the upper portion 250 to the lower portion 248 and fix the height of the meter pit 200. The adjustable height of the meter pit 200 is facilitated by an increased length of the inflow and outflow pipes 214, 216. Here, the meter pit 200 is supplied with inflow pipes 214 and outflow pipes 216 having an increased length, a portion of which is coiled within the cylindrical body 202. When the upper portion 250 is moved up or down to accommodate different installations the coiled inflow and outflow pipes 214, 216 get smaller or larger as necessary without decreasing the amount of pipe protruding out of the bottom end 206 of the cylindrical body 202.

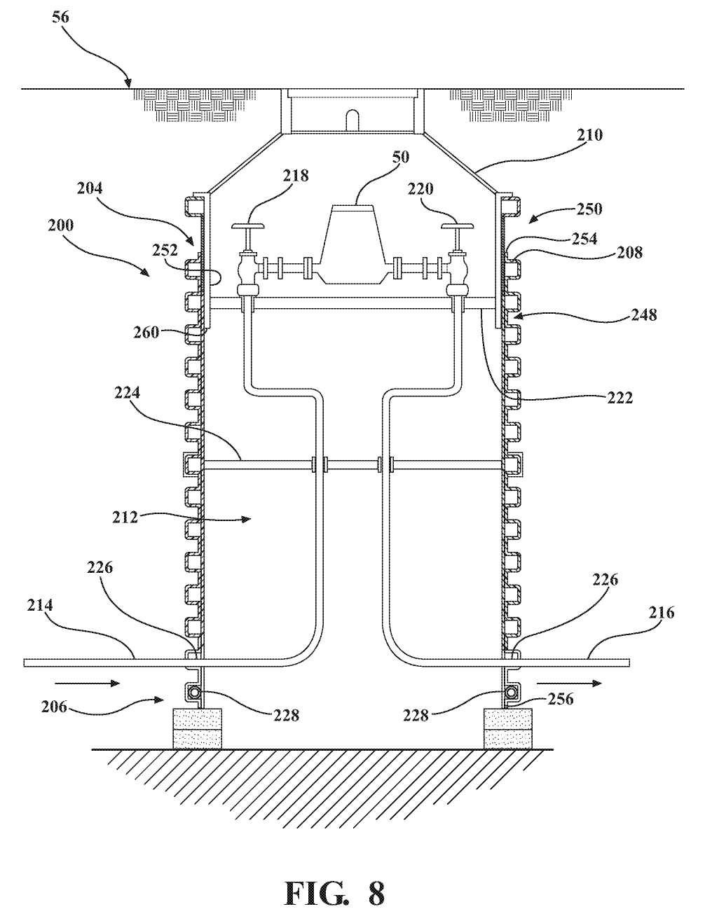

Similar to above, inlet apertures 226 are defined in the lower portion 248 of the cylindrical body 202 through which the inflow and outflow pipes 214, 216 may pass into the interior 212 of the cylindrical body 202. Here, the inlet apertures 226 are cut into the bottom opening 256 of the lower portion 248. The lower portion 248 may further include a lower rim section 228 arranged at a bottom side of each inlet aperture 226. The lower rim section 228 provides structural integrity to the inlet aperture 226 and the bottom end 206 of the cylindrical body 202. In FIG. 8, the inflow pipes 214 are shown on the left side of the interior 212 and entering through the inlet aperture 226 on the left, and the outflow pipes 216 are shown on the right side of the interior 212 and exiting through the inlet aperture 226 on the right. It should be appreciated that the inflow pipes 214 and the outflow pipes 216 can be arranged on either of the left or right sides of the interior 212 and protrude through either of the left or right inlet apertures 226, 226. In other words, the inflow pipes 214 may be arranged on the left side of the interior 212 and enter through the right inlet aperture 226 and the outflow pipes 216 may be arranged on the right side of the interior 212 and exit through the left inlet aperture 226.

Several instances have been discussed in the foregoing description. However, the aspects discussed herein are not intended to be exhaustive or limit the disclosure to any particular form. Various modifications to these aspects will be readily apparent to those skilled in the art, and the generic principles defined herein may be applied to other aspects without departing from the scope of the disclosure. The terminology that has been used is intended to be in the nature of words of description rather than of limitation. Many modifications and variations are possible in light of the above teachings and the disclosure may be practiced otherwise than as specifically described.

What is claimed is:

1. A housing for supporting one or more flow meters underground, the housing comprising:
a cylindrical body extending between a top end and a bottom end and defining an interior;
a plurality of inflow pipes, wherein each of the plurality of inflow pipes is connected to one of the one or more flow meters; and
a plurality of outflow pipes, wherein each of the plurality of outflow pipes is connected to one of the one or more flow meters.

2. The housing of claim 1, wherein the cylindrical body includes a rim extending outwardly from the top end, wherein the rim is configured to rest on a ground surface.

3. The housing of claim 1, wherein the plurality of inflow pipes and the plurality of outflow pipes are formed from a flexible polymer material and have a length greater than a distance defined between the top end and the bottom end of the cylindrical body.

4. The housing of claim 1, wherein each of the plurality of inflow pipes includes an inlet valve arranged in the interior of the cylindrical body and configured to control flow into one of the one or more flow meters.

5. The housing of claim 4, wherein each of the plurality of outflow pipes includes an outlet valve arranged in the interior of the cylindrical body and configured to control flow out of one of the one or more flow meters.

6. The housing of claim 1, further comprising a support beam arranged in the interior and extending horizontally across the cylindrical body, wherein the support beam is coupled to the cylindrical body and configured to support to at least one of the one or more flow meters.

7. The housing of claim 6, further comprising a brace arranged in the interior below the support beam and extending horizontally across the cylindrical body, wherein the brace is coupled to the cylindrical body, and wherein the plurality of inflow pipes and the plurality of outflow pipes are coupled to the brace.

8. The housing of claim 1, wherein the cylindrical body further comprises a support liner having an annular body extending between an upper end and a lower end.

9. The housing of claim 8, wherein the support liner is movably disposed inside the cylindrical body and is configured to be secured thereto.

10. The housing of claim 8, wherein the interior of the cylindrical body is configured to house the plurality of inflow pipes and the plurality of outflow pipes.

11. The housing of claim 8, wherein an inlet aperture is defined in the bottom end of the annular body, and wherein the inlet aperture enables the inflow pipes to enter the interior and the outflow pipes to exit the interior.

12. The housing of claim 11, wherein the inlet aperture is further defined as a first inlet aperture and a second inlet aperture, and wherein the inflow pipes are movably disposed in the first inlet aperture and the outflow pipes are movably disposed in the second inlet aperture.

13. The housing of claim 11, wherein the inlet aperture is secured by a flexible pipe providing structural integrity to the cylindrical body.

14. A housing for supporting a flow meter underground, the housing comprising:
a cylindrical body extending between a top end and a bottom end and defining an interior;
an aperture extending through the cylindrical body into the interior, wherein the aperture is arranged proximate to the bottom end of the cylindrical body;
a support beam arranged in the interior and coupled to the cylindrical body; and
an inflow pipe and an outflow pipe each extending through the aperture and coupled to the support beam such that the inflow pipe and the outflow pipe are at least partially arranged in the interior, wherein each of the inflow pipe and the outflow pipe is configured to be fluidly coupled to the flow meter.

15. The housing of claim 14, wherein the aperture is further defined as two inlet apertures, and wherein the inflow pipe is arranged in a first inlet aperture and the outflow pipe is arranged in a second inlet aperture.

16. The housing of claim 14, wherein the inflow pipe is further defined as two or more inflow pipes, and the outflow pipe is further defined as two or more outflow pipes.

17. The housing of claim 14, further comprising a brace arranged in the interior below the support beam and coupled to the cylindrical body, wherein the inflow pipe and the outflow pipe are coupled to the brace.

18. The housing of claim 14, wherein the cylindrical body includes a lower portion and an upper portion including a support liner, wherein the support liner is movably disposed in the lower portion and configured to adjust a height of the housing.

19. The housing of claim 18, wherein the support beam is coupled to the support liner.

20. The housing of claim 18, wherein the upper portion further includes a rim coupled to the support liner, and wherein an outer diameter of the rim is equal to an outer diameter of the lower portion.
